(19) United States
(12) Patent Application Publication
(10) Pub. No.: US 2011/0134025 A1
(43) Pub. Date: Jun. 9, 2011

(54) INPUT DEVICE

(75) Inventors: Tamotsu Yamamoto, Hyogo (JP); Noritaka Hayama, Okayama (JP); Hiroto Inoue, Kyoto (JP); Kenji Kataoka, Okayama (JP); Kenji Nishimura, Osaka (JP)

(73) Assignee: Panasonic Corporation, Osaka (JP)

(21) Appl. No.: 12/952,702

(22) Filed: Nov. 23, 2010

(30) Foreign Application Priority Data
Dec. 7, 2009 (JP) 2009-277284

(51) Int. Cl. G09G 5/00

(52) U.S. Cl. 345/156

(57) ABSTRACT

A plurality of cylindrical-shaped or spherical-shaped magnets each including the N-pole and the S-pole formed at a predetermined angle interval are rotatably placed between upper case and lower case, and a plurality of magnetic detection elements are disposed opposite to the magnets at a predetermined gap. When a plurality of small magnets having a diameter of about 2 to 3 mm are rotated by the finger, from the rotation direction and the rotation angle of the magnets the operation direction and the operation amount of the finger can be detected. Therefore, it is possible to obtain an input device capable of making an entire input device with a low dimension so as to make the device thin, and capable of reliable operation.

### BACKGROUND OF THE INVENTION

1. Field of the Invention The present invention relates to an input device mainly used to operate various electronic apparatuses.

2. Background Art

In recent years, electronic apparatuses such as portable telephones and personal computers have become more functional and decreased in size. Accordingly, input devices used to operate these apparatuses are required to be smaller and thinner and to be capable of reliable operation.

Such a conventional input device is described with reference to FIG. 9.

FIG. 9 is a sectional view showing a conventional input device. As shown in FIG. 9, operation body 11 has a spherical shape having a diameter of about 5 to 10 mm and being made of an insulating resin. Magnet 12 has a substantially disk shape and is made of, for example, ferrite. A plurality of magnets 12 are embedded in the outer periphery of operation body 11 at a predetermined interval.

Furthermore, upper case 13 and lower case 14 are made of a metal thin plate. Operation body 11 is rotatably accommodated between upper case 13 and lower case 14, an upper part of operation body 11 protrudes from an opening hole in the upper surface of upper case 13.

Furthermore, on the upper and lower surfaces of wiring board 15, a plurality of wiring patterns (not shown) are formed. On the upper surface of wiring board 15, a plurality of magnetic detection elements 16 such as Hall elements are mounted. For example, four magnetic detection elements 16 are mounted back and forth and right and left, and disposed opposite to operation body 11 with a predetermined gap. Thus, an input device is configured.

The thus configured input device is placed on an operation part (not shown) of electronic apparatuses such as portable telephones and personal computers in such a manner that the upper part of operation body 11 protrudes. A plurality of magnetic detection elements 16 are electrically connected to an electronic circuit (not shown) of the apparatus via the wiring patterns, lead wires, and the like (not shown).

In the above-mentioned configuration, a plurality of menus of, for example, singer names and song titles, and a cursor (not shown) are displayed on a display part such as a liquid crystal display element (not shown) of the apparatus. When a user operates to rotate the upper part of operation body 11 by the finger in the back-and-forth and right-and-left directions, a plurality of magnets 12 embedded in the outer periphery of operation body 11 also rotate. For example, when it is rotated in the left direction, firstly, magnet 12A approaches magnetic detection element 16 and then magnet 12B approaches magnetic detection element 16.

Then, a plurality of magnetic detection elements 16 detect magnetism of a plurality of magnets 12 that alternately approach and leave, and outputs voltage signals having phase differences with a predetermined time difference to the electronic circuit of the apparatus. Furthermore, the electronic circuit of the apparatus detects a rotation direction and a rotation angle of operation body 11 from the voltage signals. As a result, for example, the cursor or the like on the menu displayed on the display part of the apparatus is moved in the left direction by the rotation angle.

When operation body 11 is rotated in the right direction, or the back-and-forth direction, or an oblique direction between these two directions, similarly, a voltage signal is output from a plurality of magnetic detection elements 16. Then, the electronic circuit detects the rotation direction and the rotation angle of operation body 11. As a result, the cursor or the like moves in the right direction, or vertical direction, or oblique direction.

In this way, when a user rotates operation body 11 in a predetermined direction while viewing the display part of the apparatus, the user can move the cursor or the like displayed on the display part in a predetermined direction and easily select the menus.

One of such conventional techniques related to the present invention is disclosed in Japanese Patent Unexamined Publication No. 2009-123198.

However, in the above-mentioned conventional input device, a relatively large spherical-shaped operation body 11 having a diameter of about 5 to 10 mm is accommodated between upper case 13 and lower case 14 so that operation body 11 can be easily operated by the finger. Since the rotation direction and the rotation angle are detected by rotating operation body 11, the device needs to have a height to some degree. Therefore, it is difficult to make the entire input device thin.

The present invention solves such a conventional problem and provides an input device that can be made thinner and is capable of reliable operation.

### SUMMARY OF THE INVENTION

The present invention provides an input device including a plurality of substantially cylindrical-shaped or spherical-shaped magnets each having an N-pole and an S-pole disposed at a predetermined angle interval; a case in which the magnets are rotatably placed, and a plurality of magnetic detection elements disposed opposite to the magnets with a predetermined gap. A plurality of small magnets having a diameter of about 2 to 3 mm are rotated to detect a rotation direction and a rotation angle, and thereby it is possible to detect the operation direction and the operation amount of the finger. Therefore, an entire input device can be formed in low dimension, and thinning can be achieved. Furthermore, an input device capable of reliable operation can be obtained.

### BRIEF DESCRIPTION OF THE DRAWINGS

FIG. 1 is a sectional view showing an input device in accordance with a first embodiment of the present invention.

FIG. 2 is an exploded perspective view showing the input device in accordance with the first embodiment of the present invention.

FIG. 3 is a partial side view showing the input device in accordance with the first embodiment of the present invention.

FIG. 4 is a perspective view showing the input device in accordance with the first embodiment of the present invention.

FIG. 5A is a plan view showing the input device in accordance with the first embodiment of the present invention.

FIG. 5B is a plan view showing the input device in accordance with the first embodiment of the present invention.

FIG. 6 is a partial side view showing an input device in accordance with another embodiment of the present invention.

FIG. 7 is a plan view showing an input device in accordance with still another embodiment of the present invention.

FIG. 8A is a plan view showing an input device in accordance with yet another embodiment of the present invention.

FIG. 8B is a plan view showing an input device in accordance with another embodiment of the present invention.

FIG. 9 is a sectional view showing a conventional input device.

### DETAILED DESCRIPTION OF THE INVENTION

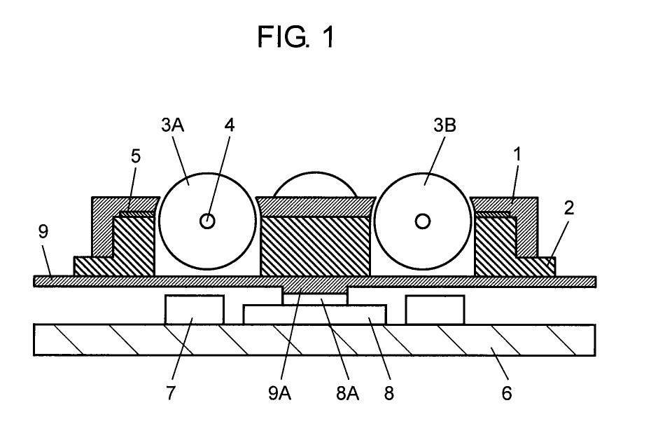

Hereinafter, embodiments of the present invention are described with reference to FIGS. 1 to 8.

Note here that these drawings are represented by partially enlarging the dimensions for easy understanding of the configuration.

### (FIRST EMBODIMENT)

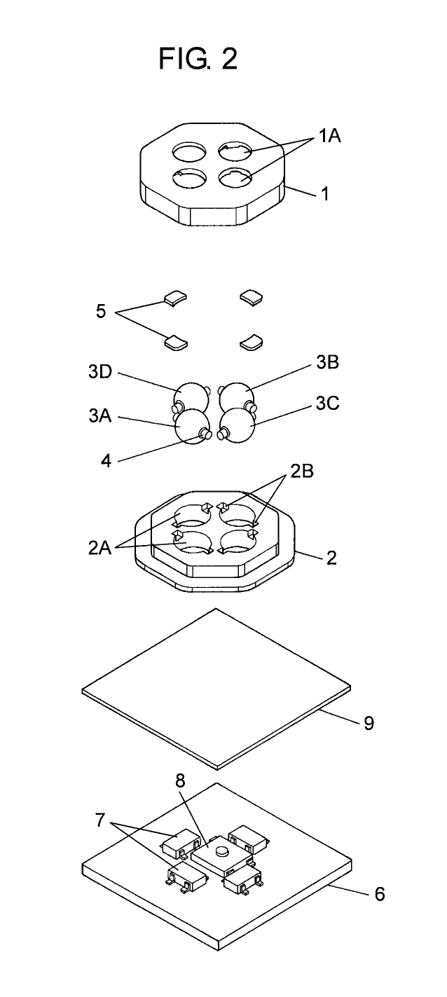

FIG. 1 is a sectional view showing an input device in accordance with a first embodiment of the present invention. FIG. 2 is an exploded perspective view showing the input device in accordance with the first embodiment of the present invention. In FIGS. 1 and 2, upper case 1 is made of an insulating resin such as ABS. Lower case 2 is made of an insulating resin such as polyacetal. Lower case 2 is provided with four elliptical-shaped openings 2A and a pair of semicircular-shaped holding parts 2B coupled to each of openings 2A. Furthermore, upper case 1 is provided with four elliptical-shaped openings 1A that are somewhat smaller than openings 2A.

Magnets 3A to 3D have a substantially elliptical shape, have a diameter of about 2 to 3 mm, and are made of ferrite, an Nd—Fe—B alloy, and the like.

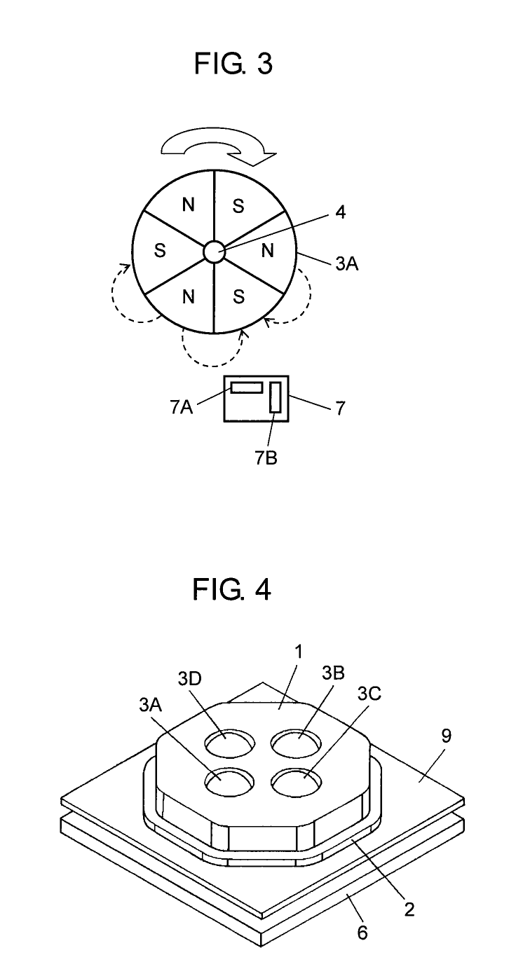

FIG. 3 is a partial side view showing the input device in accordance with the first embodiment of the present invention. In FIG. 3, the N-poles and the S-poles having different magnetisms are provided adjacent to each other at a predetermined angle interval (for example, at an interval of 60°). Furthermore, magnet 3A has a pair of cylindrical-shaped protruding portions of rotation axis 4 at its center.

Then, four magnets 3A to 3D are placed between upper case 1 and lower case 2 in a state in which rotation axis 4 is inserted into holding part 2B of lower case 2.

FIG. 4 is a perspective view showing an input device in accordance with the first embodiment of the present invention. In FIG. 4, in openings 2A (see FIG. 2), magnet 3A and magnet 3B facing magnet 3A are placed rotatably in the right-and-left direction, respectively. Furthermore, magnet 3C and magnet 3D facing magnet 3C are placed rotatably in the back-and-forth direction that is perpendicular to the direction of magnets 3A and 3B.

Magnetic substance 5 (see FIG. 2) has a substantially plate shape and is made of amorphous cobalt, iron, a permalloy, an Ni—Fe alloy, and the like. Then, four magnetic substances 5 are placed on the upper surface of lower case 2 at the sides of magnets 3A to 3D. The upper surface of lower case 2 is covered with upper case 1, and the upper parts of magnets 3A, 3B, and the like, protrude from openings 1A (see, FIG. 2) of upper case 1.

The intervals of four openings 1A, 2A, and magnets 3A to 3D are about 3 to 5 mm. Therefore, they are smaller than the dimension of about 4 to 10 mm, that is, the width of the finger, a user can touch four magnets 3A to 3D by one finger simultaneously.

Wiring board 6 is made of paper phenol or glass-containing epoxy, or the like. On the upper and lower surfaces of wiring board 6, a plurality of wiring patterns (not shown) are formed of, for example, copper foil. On the upper surface of wiring board 6 below magnets 3A to 3D, four magnetic detection elements 7 such as Hall elements for detecting magnetism in the vertical direction and GMR elements for detecting magnetism in the horizontal direction are mounted and placed.

As shown in FIG. 3, magnetic detection element 7 includes a pair of magnetic detection element 7A for detecting magnetism in the vertical direction and magnetic detection element 7B for detecting magnetism in the horizontal direction perpendicular to the vertical direction.

Switch contact 8 (see FIG. 2) is formed by, for example, a push switch. Cover sheet 9 is formed by a sheet film of, for example, polyethylene terephthalate. Switch contact 8 is mounted and placed on the upper surface of wiring board 6 in the center portion surrounded by four magnetic detection elements 7. The upper surface of wiring board 6 is covered with cover sheet 9. Convex portion 9A (see FIG. 1) formed on the lower surface of cover sheet 9 by, for example, printing is brought into contact with push-button portion 8A protruding upward from switch contact 8 (see FIG. 1)

Next, a method for producing the thus configured input device is described.

Firstly, rotation axis 4 is inserted into and fixed to a through hole at the center of each of magnets 3A to 3D. Thereafter, magnets 3A to 3D are magnetized and the N-poles and the S-poles are formed in a state in which they are adjacent to each other at a predetermined angle interval. Then, magnets 3A to 3D are rotatably placed and accommodated between upper case 1 and lower case 2. Thus, an input unit is produced.

Next, switch contact 8 and magnetic detection elements 7 are mounted and placed on the upper surface of wiring board 6. Thereafter, the upper surface of wiring board 6 is covered with cover sheet 9. Finally, the above-mentioned input unit is disposed movably in the vertical direction. Thus, an input device is completed.

In this way, in the input device in accordance with the present invention, four small magnets 3A to 3D having a diameter of about 2 to 3 mm, which are made to be not larger than the width of the finger, are rotatably placed and accommodated between upper case 1 and lower case 2. Therefore, the height of the entire device can be made to be low as about 3 to 5 mm even when the heights of wiring board 6 and switch contact 8 and the like are included. Thus, remarkable thinning can be achieved.

The thus configured input device is placed movably in the vertical direction on an operation part (not shown) of electronic apparatuses such as portable telephones and personal computers in a state in which the upper parts of magnets 3A to 3D are allowed to protrude. Furthermore, switch contact 8 and a plurality of magnetic detection elements 7 are electrically connected to an electronic circuit (not shown) of the apparatus via wiring patterns, lead wires, and the like (not shown).

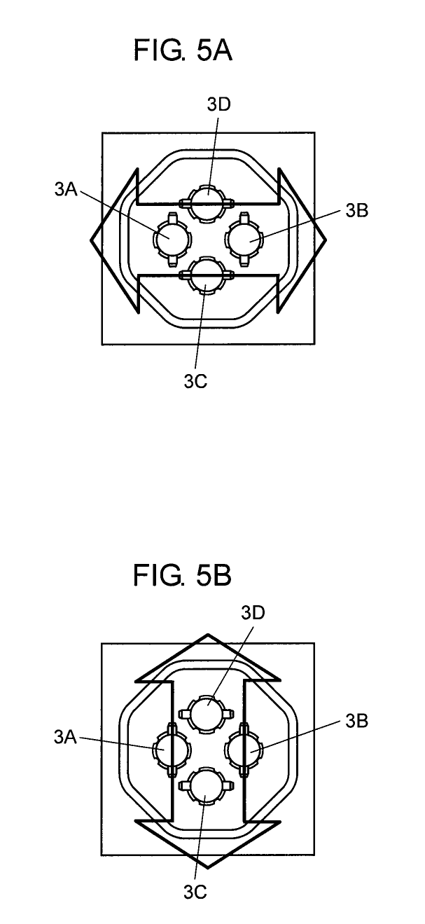

FIGS. 5A and 5B are plan views showing the input device in accordance with the first embodiment of the present invention. FIGS. 5A and 5B assume that a user touches four magnets 3A to 3D by one finger simultaneously in a state in which a plurality of menus of, for example, singer names and song titles, and a cursor (not shown), and the like, are displayed on a display part such as a liquid crystal display element (not shown) of the apparatus.

For example, as shown in a plan view of FIG. 5A, when a user moves the finger in the right-and-left direction, magnets 3C and 3D capable of rotating in the back-and-forth direction perpendicular to the right-and-left direction do not rotate. However, magnets 3A and 3B capable of rotating in the right-and-left direction rotate around rotation axis 4 (see FIG. 1) as a center.

Then, as shown in FIG. 3, magnetic detection element 7 disposed below magnet 3A detects the magnetism of magnet 3A. In magnet 3A, the N-poles and the S-poles are formed adjacent to each other at a predetermined angle interval, and the magnetism changes between the N-pole and the S-pole alternately by the rotation. At this time, magnetic detection element 7A detects magnetism in the vertical direction, and magnetic detection element 7B that is a counterpart of magnetic detection element 7A detects magnetism in the horizontal direction.

Therefore, a voltage signal output from magnetic detection element 7A and a voltage signal output from magnetic detection element 7B have a phase difference of a predetermined time difference. Then, these voltage signals are output from magnetic detection element 7 to the electronic circuit of the apparatus.

At the same time, similarly, a voltage signal with a phase difference is output also from magnetic detection element 7 below magnet 3B. Then, the electronic circuit of the apparatus detects the rotation direction and the rotation angle of magnets 3A and 3B based on the phase difference of the voltage signal, and, as a result, allows the cursor or the like on the menu displayed on the display part of the apparatus to move in the right-and-left direction by the detected rotation angle.

Next, as shown in FIG. 5B, it is assumed that a user moves the finger in the back-and-forth direction. In this case, magnets 3A and 3B capable of rotating in the right-and-left direction do not rotate, and magnets 3C and 3D capable of rotating in the back-and-forth direction rotate. Similar to the above, voltage signals with a phase difference are output from magnetic detection element 7 below magnets 3C and 3D to the electronic circuit. Then, based on the voltage signals with a phase difference, the electronic circuit detects the movement of the finger in the back-and-forth direction, and allows the cursor or the like on the display part to move in the vertical direction by the rotation angle.

Furthermore, it is assumed that a user moves the finger in an oblique direction between the above-mentioned right-and-left direction and the back-and-forth direction. In this case, four of magnets 3A and 3B as well as magnets 3C and 3D rotate. Then, a voltage signal with a phase difference is output from magnetic detection element 7 below each of the four magnets. As a result, the electronic circuit detects the movement of the finger in the oblique direction and allows the cursor or the like on the display part to move in the oblique direction.

Furthermore, it is assumed that magnets 3A to 3D are pressed in a state in which the cursor or the like is located on a desired menu. In this case, upper case 1 and lower case 2 move downward so as to bend cover sheet 9, so that convex portion 9A on the lower surface of cover sheet 9 presses push-button portion 8A. Then, switch contact 8 is electrically connected and disconnected. This state is detected by the electronic circuit of the apparatus, and the determination of the menu or display of a next menu is carried out.

Note here that when the pressing force to magnets 3A to 3D is released, push-button portion 8A presses convex portion 9A by elastic returning force of switch contact 8. Thereby, upper case 1 and lower case 2 move upward and return to the original state.

In this way, a user moves the finger touching four magnets 3A to 3D in the right-and-left direction, the back-and-forth direction, or an oblique direction between the right-and-left direction and the back-and-forth direction while viewing a display part of the apparatus. Thereby, a cursor or the like displayed on the display part can be moved in a predetermined direction. Then, by selecting the menu and pressing magnets 3A to 3D, it is possible to determine the menu or display the next menu easily.

Furthermore, four magnets 3A to 3D are rotated with the movement of the finger, and each of these rotations is detected by magnetism in the vertical direction and magnetism in the horizontal direction. In the detecting method, the movement of the finger from a voltage signal with a phase difference is detected by using a pair of magnetic detection elements 7A and 7B. Therefore, detection with high accuracy can be carried out and reliable operation can be achieved.

Furthermore, by rotating a plurality of small magnets having a diameter of about 2 to 3 mm in which the N-poles and the S-poles are provided at a predetermined angle interval, the rotation direction and the rotation angle are detected. Therefore, as mentioned above, the input device can be formed in a low dimension, and remarkable thinning can be achieved.

Furthermore, cover sheet 9 covers the upper surface of wiring board 6 on which switch contact 8 and magnetic detection elements 7 are mounted and placed. Therefore, even if some water droplets enter from gaps between magnets 3A to 3D and upper case 1 and lower case 2, they can be prevented from being attached to switch contact 8, magnetic detection elements 7, and wiring board 6.

In addition, four magnetic substances 5 are disposed on the side part of magnets 3A to 3D, respectively. Thus, they prevent the magnetic forces of four magnets 3A to 3D from influencing on each other in a small dimension. Furthermore, when magnets 3A to 3D are rotated, a good tactile feel with a click feel can be obtained.

Furthermore, in addition to the above-mentioned four magnetic substances 5, one magnetic substance 5 may be provided in the center of magnets 3A to 3D, thus preventing magnetic forces from influencing on each other. Magnetic substances 5 may be coupled in a ring shape. Alternatively, magnetic substance 5 for pressing with a tactile click feel and magnetic substance 5 for preventing a magnetic force may be provided separately, and they may be formed in different shapes.

In the first embodiment of the present invention, magnetic detection element 7 including a pair of magnetic detection element 7A for detecting magnetism in the vertical direction and magnetic detection element 7B for detecting magnetism in the horizontal direction is disposed below magnet 3A, and the like.

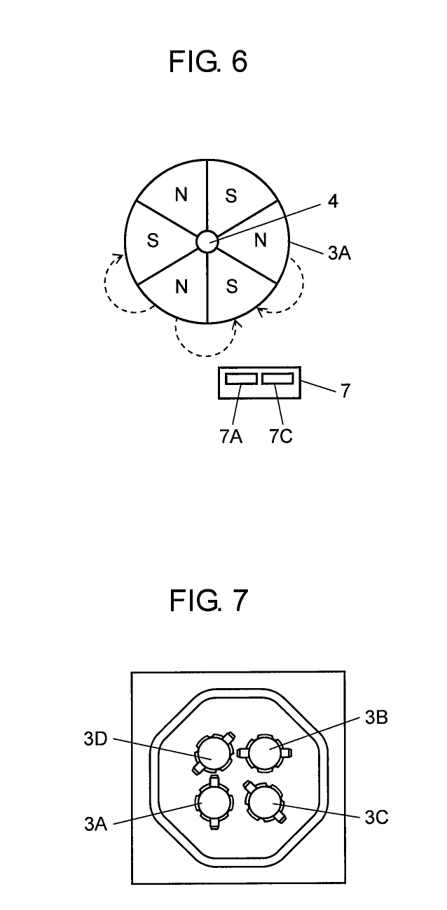

FIG. 6 is a partial side view showing an input device in accordance with another embodiment of the present invention. In FIG. 6, magnetic detection element 7, in which magnetic detection elements 7A and 7C for detecting magnetism in the vertical direction are arranged in parallel, is used. The present invention may be carried out by a configuration in which a voltage signal with a phase difference is detected based on the time difference due to the difference of these positions, thereby detecting a rotation direction and a rotation angle of magnet 3A and the like.

Furthermore, in the first embodiment of the present invention, between upper case 1 and lower case 2, magnets 3A and 3B are placed in the right-and-left direction, and magnets 3C and 3D are placed in the back-and-forth direction, respectively, in such a manner that they can rotate in the direction perpendicular to each direction.

FIG. 7 is a plan view showing an input device in accordance with still another embodiment of the present invention. In FIG. 7, magnet 3A is placed rotatably in the right-and-left direction, and magnet 3B is placed rotatably in the back-and-forth direction, respectively. Magnets 3C and 3D may be placed rotatably in the direction oblique (for example, tilted at 45°) to magnet 3A and 3B.

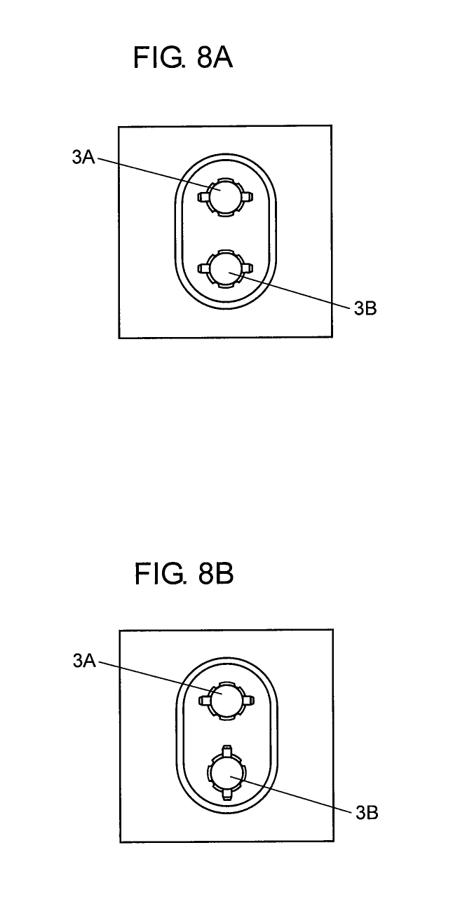

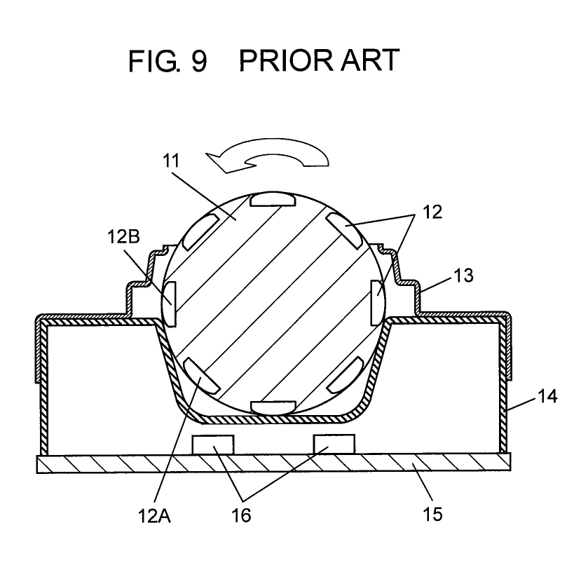

FIGS. 8A and 8B are plan views showing an input device in accordance with yet another embodiment of the present invention. In FIGS. 8A and 8B, when few directions are to be operated, instead of four magnets 3A to 3D, two magnets may be used. As shown in FIG. 8A, two magnets 3A and 3B may be placed rotatably in the same direction. Furthermore, as shown in FIG. 8B, two magnets 3A and 3B may be placed rotatably such that they can rotate in the directions perpendicular to each other. In addition, the present invention may be carried out by a configuration in which eight magnets are placed in various directions so as to detect various operation directions.

Furthermore, the first embodiment of the present invention uses magnet 3A and the like in which three N-poles and three S-poles are adjacent to each other at a predetermined angle (for example, 60°). However, although the detection accuracy is somewhat deteriorated, magnet 3A and the like in which one N-pole and one S-pole are arranged at an interval of 180° may be used. Alternatively, magnet 3A and the like in which four N-poles and four S-poles are arranged at an interval of 45° so as to enhance the detection accuracy may be used.

In addition, in the first embodiment of the present invention, the shape of magnet 3A is substantially elliptical. However, various shapes such as a cylindrical shape and a spherical shape may be employed as long as they are somewhat circular and a rotation operation can be carried out easily. With various shapes, the present invention can be carried out.

Thus, according to the embodiment, a plurality of substantially cylindrical-shaped or spherical-shaped magnets 3A to 3D, in which the N-pole and the S-pole are formed at a predetermined angle, are rotatably placed between upper case 1 and lower case 2. Then, when a plurality of magnetic detection elements 7A and 7B are disposed opposite to magnets 3A to 3D with a predetermined gap, and a plurality of small magnets 3A to 3D having a diameter of about 2 to 3 mm are rotated by the finger. Then, from the rotation directions and rotation angles thereof, the operation direction and the operation amount of the finger can be detected. Therefore, an entire device can be formed in a small dimension, and remarkably thinned. Furthermore, it is possible to obtain an input device capable of reliable operation.

Note here that in the above description, a configuration in which a push switch is mounted to form switch contact 8 on the upper surface of wiring board 6 is described. However, a plurality of stationary contacts are formed by, for example, carbon on the upper surface of wiring board 6, and a movable contact having a substantially dome shape and being made of a conductive metal thin plate may be packaged. Alternatively, a push button made of, for example, rubber, which is provided with a movable contact on the lower surface thereof may be formed on the upper part of the stationary contact. Various configurations having various switch contacts may be employed.

An input device in accordance with the present invention is advantageous that a device can be thinned and reliable operation can be carried out, and is useful mainly to operate various electronic apparatuses.

What is claimed is:

1. An input device comprising:
a plurality of magnets each having a cylindrical shape or a spherical shape and including an N-pole and an S-pole formed at a predetermined angle interval;
a case in which the magnets are rotatably placed, and
a plurality of magnetic detection elements disposed opposite to the magnets with a predetermined gap.
